(19) United States
(12) Patent Application Publication
(10) Pub. No.: US 2010/0233507 A1
(43) Pub. Date: Sep. 16, 2010

(54) DEVICE WITH AT LEAST TWO INTERCONNECTED METAL PARTS

(75) Inventors: Christoph Vogt, St. Paul, MN (US); Lena Lewandrowski, Mainhausen (DE); Stefan Schibli, Frankfurt (DE); Heiko Specht, Hanau (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: W. C. HERAEUS GMBH, Hanau (DE)

(21) Appl. No.: 12/722,697

(22) Filed: Mar. 12, 2010

(30) Foreign Application Priority Data
Mar. 13, 2009 (DE) 10 2009 012 677.5
Mar. 25, 2009 (DE) 10 2009 014 282.7

(51) Int. Cl. B32B 15/01; B23K 31/02; B23K 26/20

(52) U.S. Cl. 428/637; 428/615; 428/669; 428/680; 428/636; 228/101; 219/121.64

(57) ABSTRACT

One aspect is a device including at least two interconnected metal parts. The two interconnected parts are formed from metals with different melting temperature from the group consisting of the elements Pt, Pd, Ag, Au, Nb, Ta, Ti, Zr, W, V, Hf, Mo, Co, Cr, Ni, Ir, Re, Ru as well as alloys on the basis of at least one of those elements. The metal part with the lower melting temperature is fused onto the metal part with the higher melting temperature and both parts are friction-locked and/or form-locked with each other.

### CROSS-REFERENCE TO RELATED APPLICATIONS

This Utility patent application claims priority to German Patent Application No. DE 10 2009 012 677.5, filed on Mar. 13, 2009 and German Patent Application No. DE 10 2009 014 282.7, filed on Mar. 25, 2009, both of which are incorporated herein by reference.

### BACKGROUND

One aspect relates to a device with at least two interconnected metal parts, whereby two directly interconnected parts are formed from metals with different melting temperature from the group consisting of the elements Pt, Pd, Ag, Au, Nb, Ta, Ti, Zr, W, V, Hf, Mo, Co, Cr, Ni, Ir, Re, Ru as well as alloys on the basis of at least one of those elements, and, if applicable, with the addition of other elements. Furthermore, one aspect relates to a method for the manufacture of such a device.

Such devices have varying applications; for example, in medical engineering highly sophisticated stimulation electrodes are implanted. Such electrodes have to be connected with electrical leads. As a rule, the stimulation electrodes consist thereby of a high-fusing metal, and the leads consist of a metal with lower melting temperature. Those two components are frequently connected through laser welding. Thereby, however, it is possible that the required mechanical stability or the electrical conductivity are not achieved due to the differences between the two metals to be connected. Cracks may occur in the weld zone that are caused, among other things, by the formation of intermetallic phases or the solidification behavior after welding. Due to different melting temperatures, the fusion is, in parts, insufficient. As a rule, such defects are not detectable non-destructively, which can lead to significant problems during manufacture and/or quality assurance.

For these and other reasons there is a need for the present invention.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

In the following, aspects are explained by means of embodiment examples. The drawings illustrate:

FIG. 1 illustrates a juncture of a stimulation electrode with a lead coil prior to fusing.

FIG. 2 illustrates a juncture of a stimulation electrode with a lead coil after fusing.

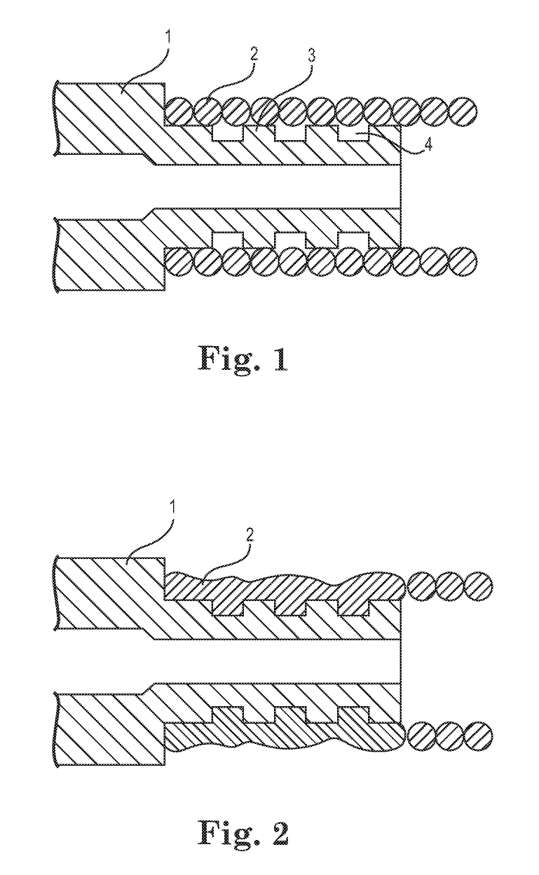

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

One embodiment provides connections between metal parts with different melting temperatures that are mechanically sufficiently sturdy and possess good electrical conductivity.

In one embodiment, the metal part with the lower melting temperature is fused onto the metal part with the higher melting temperature and both parts are friction-locked and/or form-locked with each other, thereby achieving mechanical stability and electrical conductivity of the connection. In this context, a direct connection is achieved in the connection of the two metal parts in question without the use of additional connecting elements, such as screws, rivets, etc. The different melting temperatures of the parts in question is utilized with the device, according to one embodiment, whereby only one of the parts, that is, the metal with the lower melting temperature, is fused onto the metal with the higher melting temperature, whereby the metal with the higher melting temperature remains in a solid state. Therefore, it has a solid surface during fusing. This assures that the molten metal penetrates surface irregularities of the solid part and solidifies upon contact with the solid part, providing for extensive contact with mechanical stability as well as good electrical conductivity.

Expediently, the part made of the metal with the higher melting temperature exhibits a profiled surface, for example, in the form of grooves, threads, or drillings. Even the surface roughness through machined manufacturing, for example, may possibly suffice for achieving the required form locking and/or adhesion. In one embodiment, the metal part with the lower melting temperature surrounds, at least partly, the metal part with the higher melting temperature providing for a connection on several sides of the parts to be connected. For example, one end of the metal part with the higher melting temperature can be inserted in an opening of the metal part with the lower melting temperature. Subsequently, the metal with the lower melting point is fused and practically flows onto the surface of the other part. In one embodiment, the fusing can be achieved with the help of a laser beam. Thereby, the laser beam can specifically fuse only the metal with the lower melting point.

In one embodiment, the difference of the melting temperatures of the metals of both parts is at least 1000° C., and in one embodiment, at least 1500° C. The melting temperature of the metal with higher melting point can, in one embodiment, be at least 2400° C., and in one embodiment, at least 2800° C. Thereby, the specific fusing of the metal with lower melting point is facilitated.

The device, according to one embodiment, can be designed, expediently, as part of a medical implant, for example, the part made of the metal with the lower melting temperature can be a lead coil, and the part made of the metal with the higher melting temperature can be a stimulation electrode. The lead coil serves as a feed line for electric current to the stimulation electrode. It can be used in a cardiac pacemaker, an implantable defibrillator, an implantable cardial resynchronization device, or a peripheral muscle stimulator, or a neurostimulator, or used as neurostimulation electrode or stimulation electrode for deep brain stimulation.

A principally known stimulation electrode 1 exhibits a circular profile and a contact end 3 for the connection with a lead coil 2. The contact end 3 is equipped with circumferential grooves 4. The stimulation electrode 1 can be formed from a tantalum-niobium-tungsten alloy, for example, Ta-10Nb-7.5W. The contact end of the lead coil 2 (for example, designed as a cylindrical coil) is pushed over the contact end 3 of the stimulation electrode 1 and encompasses said contact end 3. Subsequently, the contact end of the lead coil 2 is fused with the help of a laser, causing the molten metal to flow into the grooves 4. The material used for the lead coil, for example, is MP35N (MP35N is a trademark of SPS Technologies, Inc.). Essentially, MP35N exhibits approximately 35% w/w nickel, approximately 35% w/w cobalt, approximately 20% w/w chromium, and approximately 10% w/w molybdenum. Its melting point lies at approximately 1400° C. The laser power can be adjusted without problems in such a way that said material fuses and flows into the profile of the material of the stimulation electrode, which has a melting point of approximately 2800 to 3000° C., without melting the material of the stimulation electrode.

In this as well as the following examples, the stimulation electrode can be adjusted to various applications. It can be used in a cardiac pacemaker, an implantable defibrillator (ICD), an implantable cardial resynchronization device (CRT), or, for example, as peripheral muscle stimulator, neurostimulation electrode or as stimulation electrode for deep brain stimulation.

At least on its contact end 3, the stimulation electrode exhibits, in one embodiment, a circular profile onto which, in one embodiment, a cylindrical coil of the lead coil 2 is pushed. The profiles do not have to be designed as circumferential grooves 4, but can be designed in almost any random form, whereby circumferential recesses in circumferential direction or spot recesses (drillings) act well against tensile stresses.

In a further example, the lead coil is made of MP35N, and the stimulation electrode is made of tantalum. Since tantalum has a melting point of 2996° C., the temperature difference between the melting temperatures of both materials is greater than 1500° C. The profile of the stimulation electrode can be designed, among other things, as a through-hole (transversely to the longitudinal axis). In a further example, the stimulation electrode is made of Ta-10W with a melting point of 3040° C. The lead coil is formed from a core-jacket wire, whereby the core is made of tantalum, and the jacket is made of MP35N. The contact end of the stimulation electrode is designed with rectangularly circumferential grooves.

Another example exhibits a stimulation electrode made of Ta-5Nb-1Zr. The contact end of this stimulation electrode illustrates a groove in circumferential direction, onto which a core-jacket wire with a silver core and an MP35N jacket is fused. The difference between the melting temperatures of the two fused metals is greater than 1000° C.

In a further example, a niobium electrode is used as the stimulation electrode, which at its contact end exhibits several tapped blind holes arranged at the circumference. A lead coil made of MP35N is fused onto this contact end. Once again, the difference between the melting temperatures is greater than 1000° C. since the melting temperature of niobium is 2468° C.

A further stimulation electrode is made of Nb-1Zr. On its contact end it exhibits V-shaped circumferential grooves, onto which a lead coil is fused which is formed from a core jacket wire, whereby the core is made of tantalum, and the jacket is made of platinum. In one embodiment with core-jacket wires, the jacket is fused, whereby its material encompasses the contact end of the stimulation electrode and thereby guarantees the required mechanical stability and electrical conductivity.

A further stimulation electrode is made of Pt-30Ir. On its contact end it exhibits through-holes (transversely to the longitudinal axis) with which the lead coil made of MP35N is firmly attached. A further stimulation electrode made of a platinum alloy can be formed from Pt-30Ir. It can exhibit rectangularly circumferential grooves. In this example, the lead coil is made from a core-jacket wire with a silver core and an MP35N jacket. A further stimulation electrode is made of Pt-10Ir. On its contact end it exhibits a thread. The lead coil is made of MP35N.

In a further example, a lead coil made of MP35N is fused onto a stimulation electrode made of platinum and adheres due to the circumferential grooves of the stimulation electrode manufactured through lathing.

Stimulation electrodes can also be manufactured on the basis of palladium. For example, a palladium electrode with through-holes on its contact end can be connected to a lead coil made of MP35N. A further stimulation electrode made of Pd-20Ir is connected to a lead coil made of MP35N, whereby the stimulation electrode exhibits tapped blind holes. A Pd-10Ir stimulation electrode with V-shaped circumferential grooves at its contact end was connected with a lead coil made of a core-jacket wire, whereby the core is made of silver and the jacket made of MP35N. Such a lead coil was connected with a stimulation electrode made of Pd-10Ru, whereby the stimulation electrode exhibits a thread at its contact end, into which the lead coil was fused. Finally, a stimulation electrode made of Pd-10Re was provided with rectangularly circumferential grooves at its contact end and fused onto a lead coil made of MP35N.

It is understood that the type of fastening can vary with regard to the profile shape. In all cases, a flawless mechanical connection and good electrical conductivity were achieved.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A device comprising:
at least two interconnected metal parts;
wherein the two interconnected parts are formed from metals with different melting temperature from the group consisting of the elements Pt, Pd, Ag, Au, Nb, Ta, Ti, Zr, W, V, Hf, Mo, Co, Cr, Ni, Ir, Re, Ru as well as alloys on the basis of at least one of those elements;
characterized in that the metal part with the lower melting temperature is fused onto the metal part with the higher melting temperature and both parts are friction-locked and/or form-locked with each other.

2. The device according to claim 1, characterized in that the metal part with the lower melting temperature is fused onto a solid surface.

3. The device according to claim 1, characterized in that the metal part with the higher melting temperature exhibits a profiled surface.

4. The device according to claim 1, characterized in that the metal part with the lower melting temperature interlocks with the profile of the metal part with the higher melting temperature.

5. The device according to claim 1, characterized in that the metal part with the lower melting temperature surrounds, at least partly, the metal part with the higher melting temperature.

6. The device according to claim 1, characterized in that the difference of the melting temperatures of both parts is at least 1000° C.

7. The device according to claim 1, characterized in that the melting temperature of the metal with higher melting point is at least 2400° C.

8. The device according to claim 1, characterized in that it is a medical implant.

9. The device according to claim 8, characterized in that the part made of the metal with the lower melting temperature is a lead coil, and the part made of the metal with the higher melting temperature is a stimulation electrode.

10. A method for the manufacture of a device according to claim 1, characterized in that the metal part with the lower melting temperature is fused onto the metal part with the higher melting temperature.

11. The method according to claim 10, characterized in that the fusing is achieved by means of a laser.

12. The method according to claim 11, characterized in that the laser only fuses the metal with the lower melting point.

13. A component for a medical device comprising:
first and second metal parts configured such that the first metal part has a lower melting temperature than the second metal part;
wherein the first and second metal parts are each formed from the group consisting of the elements Pt, Pd, Ag, Au, Nb, Ta, Ti, Zr, W, V, Hf, Mo, Co, Cr, Ni, Ir, Re, Ru as well as alloys on the basis of at least one of those elements; and
wherein the first metal part is fused onto the second metal part such that both parts are directly locked together.

14. The component according to claim 13, wherein in that the second metal part exhibits a profiled surface.

15. The component according to claim 13, wherein the melting temperature of the second metal part is at least 1000° C. higher than the melting temperature of the first metal part.

16. The component according to claim 13, wherein the melting temperature of the second metal part is at least 1500° C. higher than the melting temperature of the first metal part.

17. The device according to claim 13, wherein the melting temperature of the second metal part is at least 2400° C.

18. A method of manufacturing a device having at least two interconnected metal parts, the method comprising:
fusing a metal part with a lower melting temperature onto a metal part with the higher melting temperature;
wherein the two interconnected parts are formed from metals with different melting temperature from the group consisting of the elements Pt, Pd, Ag, Au, Nb, Ta, Ti, Zr, W, V, Hf, Mo, Co, Cr, Ni, Ir, Re, Ru as well as alloys on the basis of at least one of those elements; and
fusing the metal part with the lower melting temperature onto the metal part with the higher melting temperature such that both parts are locked with each other.

19. The method according to claim 18 further comprising fusing the metal parts with a laser.

20. The method according to claim 19 further comprising fusing with the laser only the metal with the lower melting point.
